(19) United States
(12) Patent Application Publication
(10) Pub. No.: US 2026/0361212 A1
(43) Pub. Date: Nov. 12, 2026

(54) POWER SUPPLY AND OPERATING METHOD THEREOF

(71) Applicant: Delta Electronics, Inc., Taoyuan City (TW)

(72) Inventors: Sheng-Jian Chen, Taoyuan City (TW); Ming-Wei Chou, Taoyuan City (TW); Chia-Chang Hsu, Taoyuan City (TW)

(21) Appl. No.: 19/246,416

(22) Filed: Jun. 23, 2025

(30) Foreign Application Priority Data
May 9, 2025 (CN) 202510595926.8

(51) Int. Cl. H02M 1/44; H02M 1/08; H02M 1/32

(52) U.S. Cl. CPC H02M 1/44; H02M 1/08; H02M 1/32

(57) ABSTRACT

A power supply and an operating method thereof are provided. The power supply includes a conversion module, a sampling circuit, a switch circuit and a status display circuit. When the conversion module is in normal operating state, the sampling circuit generates a switch control signal according to AC component signal of voltage signal of transformer of the conversion module to configure the switch circuit to be in conducting state so that the status display circuit is electrically coupled to the signal power supply terminal through the switch circuit and correspondingly generates operation status information. When the conversion module is not in normal operating state, the sampling circuit generates the switch control signal according to the voltage signal to configure the switch circuit to be in non-conducting state so that the status display circuit is not electrically coupled to the signal power supply terminal and correspondingly generates the operation status information.

### CROSS-REFERENCE TO RELATED APPLICATION

This application claims priority to China Patent Application No. 202510595926.8, filed on May 9, 2025, and the entire contents of which are incorporated herein by reference for all purposes.

### FIELD OF THE INVENTION

The present disclosure relates to a power supply and an operating method thereof, and more particularly to a power supply and an operating method thereof that can avoid the misjudgment of the internal mechanism caused by external voltage variations.

### BACKGROUND OF THE INVENTION

When output terminals of multiple power supplies are electrically coupled in parallel to supply power to a load collaboratively, a situation that the output voltage of one power supply is higher may occur, which would cause the voltages values at the output terminals of other power supplies to increase and result in abnormal operation. In addition, such an increase in the external voltage value at the output terminal may originate from other power supplies, motors, energy storage components (e.g., capacitors), or loads (e.g., inductive loads), and this phenomenon is hereinafter referred to as backfeed voltage.

When the backfeed voltage phenomenon occurs, the control logic of the power supply may misjudge the current operating state because of receiving an unexpected voltage signal. For example, when the backfeed voltage exists, the controller of the power supply may misjudge that the power supply is still in a normal output state and correspondingly control the power supply to operate wrongly, or incorrect operation status information may be generated, resulting in improper use by operators and even damaging the power supply and the load.

### SUMMARY OF THE INVENTION

The present disclosure provides a power supply and an operating method thereof in order to overcome the drawbacks of the conventional technologies.

In accordance with an aspect of the present disclosure, a power supply is provided. The power supply includes a conversion module, a sampling circuit, a switch circuit and a status display circuit. The conversion module includes an input terminal, an output terminal, a primary-side circuit, a transformer and a secondary-side circuit. A primary winding and a secondary winding of the transformer are electrically coupled to the primary-side circuit and the secondary-side circuit respectively. When the conversion module is in a normal operating state, the conversion module is configured to generate an output voltage at the output terminal according to an input voltage received at the input terminal. The sampling circuit is electrically coupled to at least one of the primary winding, the secondary winding and an auxiliary winding of the transformer to receive a voltage signal. The sampling circuit is configured to filter out a DC component signal of the voltage signal and correspondingly generate a switch control signal. The switch circuit is electrically coupled to the sampling circuit and a signal power supply terminal, and is configured to receive the switch control signal. The status display circuit is electrically coupled to the switch circuit, and is configured to generate an operation status information of the conversion module. When the conversion module is in the normal operating state, the sampling circuit is configured to generate the switch control signal according to an AC component signal of the voltage signal to configure the switch circuit to be in a conducting state so that the status display circuit is electrically coupled to the signal power supply terminal through the switch circuit and correspondingly generates the operation status information indicating that the conversion module is in the normal operating state. When the conversion module is not in the normal operating state, the sampling circuit is configured to generate the switch control signal according to the voltage signal to configure the switch circuit to be in a non-conducting state so that the status display circuit is not electrically coupled to the signal power supply terminal and correspondingly generates the operation status information indicating that the conversion module is not in the normal operating state.

In accordance with another aspect of the present disclosure, an operating method of a power supply is provided. The power supply includes a conversion module, a sampling circuit, a switch circuit and a status display circuit. The conversion module includes an input terminal, an output terminal, a primary-side circuit, a transformer and a secondary-side circuit. A primary winding and a secondary winding of the transformer are electrically coupled to the primary-side circuit and the secondary-side circuit respectively. The sampling circuit is electrically coupled to at least one of the primary winding, the secondary winding and an auxiliary winding of the transformer. The switch circuit is electrically coupled to the sampling circuit and a signal power supply terminal. The status display circuit is electrically coupled to the switch circuit. The operating method includes: configuring the conversion module to generate an output voltage at the output terminal according to an input voltage received at the input terminal when the conversion module is in a normal operating state; configuring the sampling circuit to receive a voltage signal of the transformer, filter out a DC component signal of the voltage signal, and correspondingly generate a switch control signal; configuring the switch circuit to receive the switch control signal; configuring the status display circuit to generate an operation status information of the conversion module; when the conversion module is in the normal operating state, configuring the sampling circuit to generate the switch control signal according to an AC component signal of the voltage signal, wherein the switch control signal configures the switch circuit to be in a conducting state so that the status display circuit is electrically coupled to the signal power supply terminal through the switch circuit and correspondingly generates the operation status information indicating that the conversion module is in the normal operating state; and when the conversion module is not in the normal operating state, configuring the sampling circuit to generate the switch control signal according to the voltage signal, wherein the switch control signal configures the switch circuit to be in a non-conducting state so that the status display circuit is not electrically coupled to the signal power supply terminal and correspondingly generates the operation status information indicating that the conversion module is not in the normal operating state.

In the present disclosure, whether the backfeed voltage exists inside the power supply is determined according to the voltage signal across the secondary winding of the transformer, and the operation status information of the power supply is generated correspondingly. Consequently, the misjudgment of the operation status information caused by the backfeed voltage is avoided, and the reliability of the operation status information is improved.

### BRIEF DESCRIPTION OF THE DRAWINGS

FIG. 1 is a schematic block diagram illustrating a power supply according to an embodiment of the present disclosure;

FIG. 2 schematically shows the circuit structure of the sampling circuit 2 in FIG. 1; and

FIG. 3 is a schematic block diagram illustrating a variant of the power supply of FIG. 1.

### DETAILED DESCRIPTION OF THE PREFERRED EMBODIMENT

The present disclosure will now be described more specifically with reference to the following embodiments. It is to be noted that the following descriptions of preferred embodiments of this disclosure are presented herein for purpose of illustration and description only. It is not intended to be exhaustive or to be limited to the precise form disclosed.

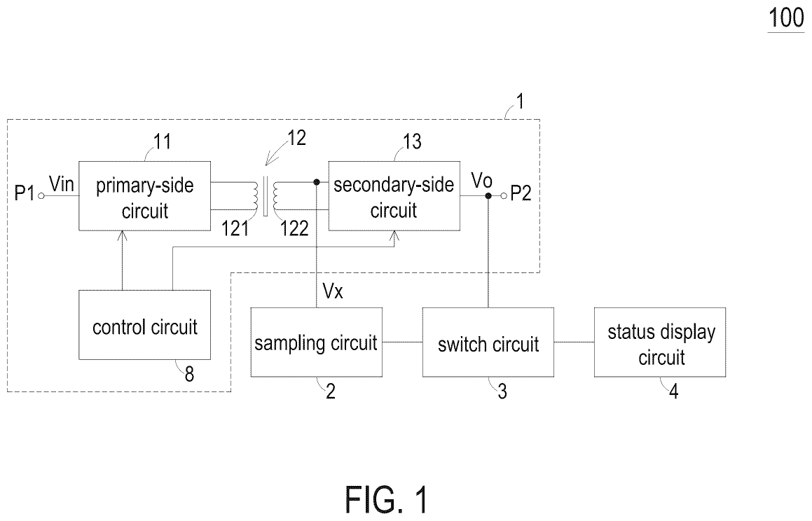

Please refer to FIG. 1. FIG. 1 is a schematic block diagram illustrating a power supply according to an embodiment of the present disclosure. In the embodiment shown in FIG. 1, the power supply 100 includes a conversion module 1, a sampling circuit 2, a switch circuit 3, and a status display circuit 4. The conversion module 1 includes an input terminal P1, an output terminal P2, a primary-side circuit 11, a transformer 12, a secondary-side circuit 13, and a control circuit 8. A primary winding 121 and a secondary winding 122 of the transformer 12 are electrically coupled to the primary-side circuit 11 and the secondary-side circuit 13 respectively. The control circuit 8 is electrically coupled to the primary-side circuit 11 and the secondary-side circuit 13, and is configured to control the operation of the primary-side circuit 11 and the secondary-side circuit 13 (e.g., controlling switching operations in the primary-side circuit 11 and the secondary-side circuit 13). The sampling circuit 2 is electrically coupled to the secondary winding 122 of the transformer 12. The switch circuit 3 is electrically coupled to the sampling circuit 2 and the output terminal P2 of the conversion module 1. The status display circuit 4 is electrically coupled to the switch circuit 3. For the sake of brevity, other components of the power supply 100 are not depicted in FIG. 1. In this embodiment, the power supply 100 is divided into the conversion module 1, the sampling circuit 2, the switch circuit 3, and the status display circuit 4 for clearly describing the operation of the power supply 100. The conversion module 1, the sampling circuit 2, the switch circuit 3, and the status display circuit 4 may be implemented by suitable components respectively, or may be integrated into or separately implemented by one or more components. In another embodiment, the functions of the conversion module 1, the sampling circuit 2, the switch circuit 3, and the status display circuit 4 may be performed by the same circuit formed by discrete components and/or integrated circuit components.

The conversion module 1 is configured to receive an input voltage Vin at the input terminal P1 and provide an output voltage Vo at the output terminal P2 after performing power conversion. When the conversion module 1 is in a normal operating state, the conversion module 1 generates the output voltage Vo at the output terminal P2 according to the input voltage Vin received at the input terminal P1. When the conversion module 1 is not in the normal operating state (e.g., in a sleep state, pause, or stopped state), the conversion module 1 does not generate the output voltage Vo according to the input voltage Vin.

The sampling circuit 2 is configured to receive a voltage signal Vx across the secondary winding 122 of the transformer 12, and the sampling circuit 2 filters out a DC component signal of the voltage signal Vx and correspondingly generates a switch control signal. The switch circuit 3 may be implemented by semiconductor switches or one or more other suitable switching elements. The control terminal of the switch circuit 3 receives the switch control signal generated by the sampling circuit 2. The switch circuit 3 is in a conducting state or a non-conducting state according to the switch control signal so that the status display circuit 4 is correspondingly electrically coupled to or not electrically coupled to the output terminal P2 of the conversion module 1. The status display circuit 4 is configured to generate operation status information of the conversion module 1, and the operation status information indicates whether the conversion module 1 is in the normal operating state.

When the conversion module 1 is in the normal operating state, the control circuit 8 configures the primary-side circuit 11 and the secondary-side circuit 13 to perform power conversion (e.g., controlling the switches of the primary-side circuit 11 and the secondary-side circuit 13 to intermittently conduct so as to perform one or more of DC-DC conversion, AC-AC conversion, AC-DC conversion, DC-AC conversion, boost conversion, and buck conversion). Correspondingly, the currents flowing through the primary winding 121 and the secondary winding 122 of the transformer 12 vary, thereby enabling power transmission based on electromagnetic coupling. Therefore, the voltage signal Vx across the secondary winding 122 also varies and includes an AC component signal. The sampling circuit 2 generates the switch control signal according to the AC component signal of the voltage signal Vx to configure the switch circuit 3 to be in the conducting state so that the status display circuit 4 is electrically coupled to the output terminal P2 of the conversion module 1 through the switch circuit 3 and correspondingly generates the operation status information of the conversion module 1.

When the conversion module 1 is not in the normal operating state, the voltage signal Vx across the secondary winding 122 does not include the AC component signal. For example, when the input terminal P1 of the conversion module 1 does not receive the input voltage Vin, or when the control circuit 8 does not configure the primary-side circuit 11 and the secondary-side circuit 13 to perform power conversion, the currents flowing through the primary winding 121 and the secondary winding 122 of the transformer 12 do not vary, and thus the voltage signal Vx across the secondary winding 122 does not include the AC component signal or does not include a sufficiently large AC component signal. When the conversion module 1 is not in the normal operating state, the voltage value of the secondary winding 122 of the transformer 12 may increase if the output terminal P2 of the conversion module 1 receives a backfeed voltage. Since the backfeed voltage is substantially a DC voltage or an AC voltage with low-frequency variation (e.g., an AC voltage varying at 50 Hz or 60 Hz, which is low compared to the switching frequency of the switches of the primary-side circuit 11 and the secondary-side circuit 13 that typically operate at 1 kHz or above 10 kHz), the backfeed voltage cannot cause the voltage value of the secondary winding 122 of the transformer 12 to have a sufficiently large AC component signal to turn on the switch circuit 3. For example, when the power supply 100 is applied in a scenario where output terminals P2 of multiple power supplies 100 are electrically coupled in parallel to supply power, the backfeed voltage received at the output terminal P2 of the power supply 100 may originate from the output voltage generated by another power supply.

Consequently, when the conversion module 1 is not in the normal operating state, the voltage signal Vx across the secondary winding 122 does not include an AC component signal or does not include a sufficiently large AC component signal. Therefore, the sampling circuit 2 correspondingly generates the switch control signal which configures the switch circuit 3 to be in the non-conducting state so that the status display circuit 4 is not electrically coupled to the output terminal P2 of the conversion module 1 and correspondingly generates the operation status information indicating that the conversion module 1 is not in the normal operating state.

Accordingly, in the power supply 100 of the present disclosure, whether the conversion module 1 is in the normal operating state is determined according to the voltage signal Vx across the secondary winding 122 of the transformer 12, and the operation status information is generated correspondingly. Therefore, the reliability of the operation status information is improved. Moreover, when a backfeed voltage exists inside the power supply 100, the operation status information indicating that the conversion module 1 is not in the normal operating state is generated correspondingly, thereby avoiding the misjudgment of the operating state of the conversion module 1 caused by the backfeed voltage.

The specific presentation of the operation status information may be determined according to actual requirements. For example, in an embodiment, the status display circuit 4 includes a light-emitting diode configured to display the operation status information. The light-emitting diode indicates that the conversion module 1 is in the normal operating state when the light-emitting diode is turned on and emits light, and the light-emitting diode indicates that the conversion module 1 is not in the normal operating state when the light-emitting diode is turned off and does not emit light. In this way, the light-emitting diode can instantly display whether the conversion module 1 is in the normal operating state or not through emitting light or not. Additionally, in another embodiment, the status display circuit includes a signal generator configured to generate a signal including the operation status information, and the operation status information is provided to relevant control components through this signal.

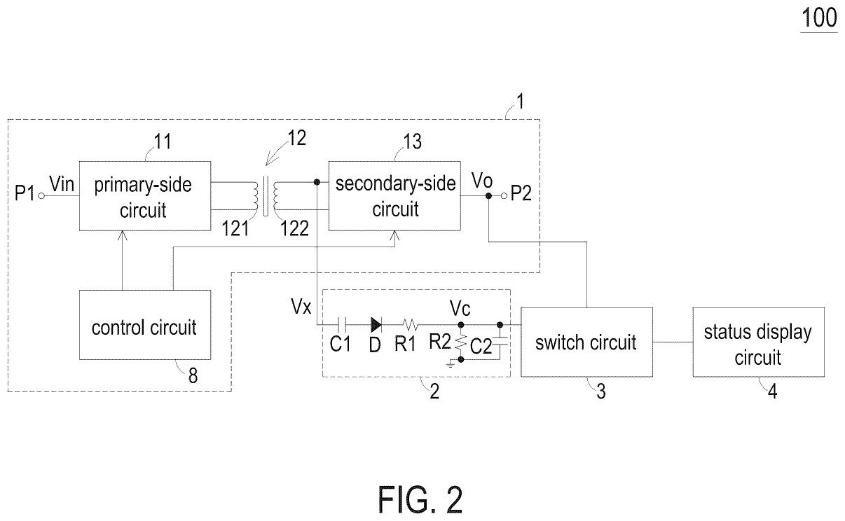

Please refer to FIG. 2. FIG. 2 schematically shows the circuit structure of the sampling circuit 2 in FIG. 1. As shown in FIG. 2, the sampling circuit 2 includes a first capacitor C1, a diode D, a first resistor R1, a second resistor R2, and a second capacitor C2. A first terminal of the first capacitor C1 is electrically coupled to the secondary winding 122 of the transformer 12. The diode D is electrically coupled between the first capacitor C1 and the first resistor R1, and the anode and cathode of the diode D are electrically coupled to a second terminal of the first capacitor C1 and a first terminal of the first resistor R1 respectively so that the second terminal of the first capacitor C1 is electrically coupled to the first terminal of the first resistor R1 through the diode D. A second terminal of the first resistor R1 is electrically coupled to a first terminal of the second resistor R2, and a second terminal of the second resistor R2 is grounded. The second capacitor C2 is electrically coupled in parallel to the second resistor R2.

The first capacitor C1 forms a DC filtering circuit, which receives the voltage signal Vx across the secondary winding 122 and is configured to filter out the DC component signal of the voltage signal Vx. The diode D is configured to prevent signal backfeed. The first resistor R1 and the second resistor R2 form a level adjustment circuit, which is configured to adjust the voltage level Vc of the switch control signal. The second capacitor C2 forms a filter circuit, which is configured to filter and stabilize the voltage signal Vx to generate the switch control signal.

Consequently, when the conversion module 1 is in the normal operating state, the sampling circuit 2 utilizes the first capacitor C1 to filter the voltage signal Vx to receive the AC component signal of the voltage signal Vx. After the voltage signal Vx is divided by the first resistor R1 and the second resistor R2, the voltage signal Vx charges the second capacitor C2 to generate the switch control signal correspondingly, thereby configuring the switch circuit 3 to be in the conducting state. When the conversion module 1 is not in the normal operating state, the DC component signal of the voltage signal Vx is filtered out by the DC filtering circuit formed by the first capacitor C1, and the AC component signal of the voltage signal Vx is not sufficient to charge the second capacitor C2 to generate a sufficiently high voltage value, thus failing to turn on the switch circuit 3. Accordingly, the switch control signal correspondingly generated by the sampling circuit 2 causes the switch circuit 3 to be in the non-conducting state.

It is noted that the circuit topology of the sampling circuit 2 in the present disclosure is not limited to the example shown in FIG. 2 and may be adjusted according to actual requirements (e.g., by increasing or decreasing the components included in the sampling circuit 2). For instance, the filtering band of the DC filtering circuit including the first capacitor C1 may be adjusted such that the backfeed voltage with lower-frequency variation is filtered out while the AC component signal with higher-frequency from the secondary-side circuit 13 is allowed to pass.

In addition to the status display circuit 4, internal protection mechanisms of the power supply 100 (for example but not limited to overvoltage protection and over-temperature protection) may also avoid misjudgment or false triggering due to backfeed voltage based on the foregoing operating manner of the sampling circuit 2.

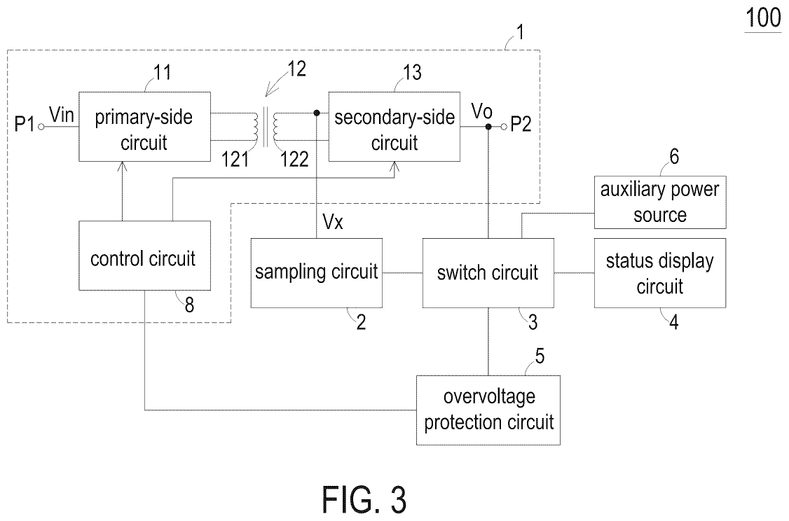

For example, in an embodiment, as shown in FIG. 3, the power supply 100 further includes an overvoltage protection circuit 5. The overvoltage protection circuit 5 is electrically coupled to the switch circuit 3, and the switch circuit 3 is electrically coupled to an auxiliary power source 6. The auxiliary power source 6 may be electrically coupled to the output terminal P2 or another suitable power input terminal to provide auxiliary power output. When the conversion module 1 is in the normal operating state, the sampling circuit 2 configures the switch circuit 3 to electrically couple the auxiliary power source 6 to the overvoltage protection circuit 5. When the output voltage Vo generated at the output terminal P2 of the conversion module 1 is greater than a threshold voltage, the overvoltage protection circuit 5 configures the conversion module 1 to reduce the output voltage Vo or suspend the power conversion operation (i.e., stop providing the output voltage Vo temporarily), thereby realizing overvoltage protection. When the conversion module 1 is not in the normal operating state, the sampling circuit 2 configures the switch circuit 3 through the switch control signal such that the auxiliary power source 6 and the overvoltage protection circuit 5 are electrically isolated from each other. Therefore, the overvoltage protection circuit 5 does not trigger overvoltage protection. Accordingly, when the output terminal P2 receives a backfeed voltage, the overvoltage protection circuit 5 would not mistakenly activate the overvoltage protection due to the backfeed voltage. In an embodiment, the overvoltage protection circuit 5 is further electrically coupled to the control circuit 8. The overvoltage protection circuit 5 generates a protection signal when the output voltage Vo generated at the output terminal P2 of the conversion module 1 is greater than a threshold voltage. The control circuit 8 controls the primary-side circuit 11 and/or the secondary-side circuit 13 according to the protection signal to configure the conversion module 1 to reduce the output voltage Vo or suspend the power conversion operation.

In the above embodiments, the sampling circuit is configured to be electrically coupled to the secondary winding of the transformer. In another embodiment, the sampling circuit may be configured to be electrically coupled to at least one of the primary winding, secondary winding, and auxiliary winding of the transformer directly or indirectly. The sampling circuit receives the AC signal of the transformer and is not affected by the backfeed voltage, and the sampling circuit generates the switch control signal correspondingly to configure the conduction state of the switch circuit. In the above embodiments, one terminal of the switch circuit is electrically coupled to the output terminal of the conversion module or the auxiliary power source which serves as the signal power supply terminal. Accordingly, when the switch circuit is in the conducting state, the signal power supply terminal supplies power to the status display circuit and other components. In another embodiment, the signal power supply terminal electrically coupled to the switch circuit may be configured as the auxiliary winding of the transformer, so that the signal power supply terminal supplies power to the status display circuit and other components when the switch circuit is in the conducting state.

While the disclosure has been described in terms of what is presently considered to be the most practical and preferred embodiments, it is to be understood that the disclosure needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A power supply, comprising:
a conversion module, comprising an input terminal, an output terminal, a primary-side circuit, a transformer and a secondary-side circuit, wherein a primary winding and a secondary winding of the transformer are electrically coupled to the primary-side circuit and the secondary-side circuit respectively, and when the conversion module is in a normal operating state, the conversion module is configured to generate an output voltage at the output terminal according to an input voltage received at the input terminal;
a sampling circuit, electrically coupled to at least one of the primary winding, the secondary winding and an auxiliary winding of the transformer to receive a voltage signal, wherein the sampling circuit is configured to filter out a DC component signal of the voltage signal and correspondingly generate a switch control signal;
a switch circuit, electrically coupled to the sampling circuit and a signal power supply terminal, and configured to receive the switch control signal;
and a status display circuit, electrically coupled to the switch circuit, and configured to generate an operation status information of the conversion module;
wherein when the conversion module is in the normal operating state, the sampling circuit is configured to generate the switch control signal according to an AC component signal of the voltage signal to configure the switch circuit to be in a conducting state so that the status display circuit is electrically coupled to the signal power supply terminal through the switch circuit and correspondingly generates the operation status information indicating that the conversion module is in the normal operating state;
wherein when the conversion module is not in the normal operating state, the sampling circuit is configured to generate the switch control signal according to the voltage signal to configure the switch circuit to be in a non-conducting state so that the status display circuit is not electrically coupled to the signal power supply terminal and correspondingly generates the operation status information indicating that the conversion module is not in the normal operating state.

2. The power supply according to claim 1, further comprising an overvoltage protection circuit electrically coupled to the switch circuit, wherein when the conversion module is in the normal operating state, the sampling circuit configures the switch circuit to electrically couple the signal power supply terminal to the overvoltage protection circuit; and when the output voltage of the conversion module is greater than a threshold voltage, the overvoltage protection circuit configures the conversion module to reduce the output voltage or suspend power conversion operation.

3. The power supply according to claim 1, wherein the sampling circuit comprises:
a DC filtering circuit, configured to receive the voltage signal and filter out the DC component signal of the voltage signal;
a level adjustment circuit, electrically coupled to the DC filtering circuit, and configured to adjust a voltage level of the switch control signal; and
a filter circuit, electrically coupled to the level adjustment circuit, and configured to filter the voltage signal to generate the switch control signal.

4. The power supply according to claim 3, wherein the DC filtering circuit comprises a first capacitor, the level adjustment circuit comprises a first resistor and a second resistor, and the filter circuit comprises a second capacitor; a first terminal of the first capacitor is electrically coupled to the transformer, a second terminal of the first capacitor is electrically coupled to a first terminal of the first resistor, a second terminal of the first resistor is electrically coupled to a first terminal of the second resistor, a second terminal of the second resistor is grounded, and the second capacitor is electrically coupled in parallel to the second resistor.

5. The power supply according to claim 4, wherein the sampling circuit further comprises a diode electrically coupled to the first capacitor and the first resistor, and an anode and a cathode of the diode are electrically coupled to the second terminal of the first capacitor and the first terminal of the first resistor respectively.

6. An operating method of a power supply, wherein the power supply comprises a conversion module, a sampling circuit, a switch circuit and a status display circuit, the conversion module comprises an input terminal, an output terminal, a primary-side circuit, a transformer and a secondary-side circuit, a primary winding and a secondary winding of the transformer are electrically coupled to the primary-side circuit and the secondary-side circuit respectively, the sampling circuit is electrically coupled to at least one of the primary winding, the secondary winding and an auxiliary winding of the transformer, the switch circuit is electrically coupled to the sampling circuit and a signal power supply terminal, the status display circuit is electrically coupled to the switch circuit, and the operating method comprises:
configuring the conversion module to generate an output voltage at the output terminal according to an input voltage received at the input terminal when the conversion module is in a normal operating state;
configuring the sampling circuit to receive a voltage signal of the transformer, filter out a DC component signal of the voltage signal, and correspondingly generate a switch control signal;
configuring the switch circuit to receive the switch control signal;
configuring the status display circuit to generate an operation status information of the conversion module;
when the conversion module is in the normal operating state, configuring the sampling circuit to generate the switch control signal according to an AC component signal of the voltage signal, wherein the switch control signal configures the switch circuit to be in a conducting state so that the status display circuit is electrically coupled to the signal power supply terminal through the switch circuit and correspondingly generates the operation status information indicating that the conversion module is in the normal operating state; and
when the conversion module is not in the normal operating state, configuring the sampling circuit to generate the switch control signal according to the voltage signal, wherein the switch control signal configures the switch circuit to be in a non-conducting state so that the status display circuit is not electrically coupled to the signal power supply terminal and correspondingly generates the operation status information indicating that the conversion module is not in the normal operating state.

7. The operating method according to claim 6, wherein the power supply further comprises an overvoltage protection circuit electrically coupled to the switch circuit, and the operating method further comprises:
when the conversion module is in the normal operating state, configuring the sampling circuit to configure the switch circuit to electrically couple the signal power supply terminal to the overvoltage protection circuit; and
configuring the overvoltage protection circuit to configure the conversion module to reduce the output voltage or suspend power conversion operation when the output voltage of the conversion module is greater than a threshold voltage.

8. The operating method according to claim 6, wherein the sampling circuit comprises a DC filtering circuit, a level adjustment circuit and a filter circuit, the level adjustment circuit is electrically coupled to the DC filtering circuit, the filter circuit is electrically coupled to the level adjustment circuit, and the operating method further comprises:
configuring the DC filtering circuit to receive the voltage signal and filter out the DC component signal of the voltage signal;
configuring the level adjustment circuit to adjust a voltage level of the switch control signal; and
configuring the filter circuit to filter the voltage signal to generate the switch control signal.

9. The operating method according to claim 8, wherein the DC filtering circuit comprises a first capacitor, the level adjustment circuit comprises a first resistor and a second resistor, and the filter circuit comprises a second capacitor; a first terminal of the first capacitor is electrically coupled to the transformer, a second terminal of the first capacitor is electrically coupled to a first terminal of the first resistor, a second terminal of the first resistor is electrically coupled to a first terminal of the second resistor, a second terminal of the second resistor is grounded, and the second capacitor is electrically coupled in parallel to the second resistor.

10. The operating method according to claim 9, wherein the sampling circuit further comprises a diode electrically coupled to the first capacitor and the first resistor, and an anode and a cathode of the diode are electrically coupled to the second terminal of the first capacitor and the first terminal of the first resistor respectively.
